(19) United States
(12) Patent Application Publication
(10) Pub. No.: US 2013/0032711 A1
(43) Pub. Date: Feb. 7, 2013

(54) Mass Spectrometer

(71) Applicants: Koji ISHIGURO, Hitachinaka (JP); Masuyoshi Yamada, Ichikawa (JP); Hidetoshi Morokuma, Hitachinaka (JP); Masuyuki Sugiyama, Hino (JP); Yuichiro Hashimoto, Tachikawa (JP)

(72) Inventors: Koji ISHIGURO, Hitachinaka (JP); Masuyoshi Yamada, Ichikawa (JP); Hidetoshi Morokuma, Hitachinaka (JP); Masuyuki Sugiyama, Hino (JP); Yuichiro Hashimoto, Tachikawa (JP)

(73) Assignee: Hitachi High-Technologies Corporation, Tokyo (JP)

(21) Appl. No.: 13/565,286

(22) Filed: Aug. 2, 2012

(30) Foreign Application Priority Data
Aug. 4, 2011 (JP) 2011-171213

(51) Int. Cl. H01J 49/26

(52) U.S. Cl. 250/288

(57) ABSTRACT

A unit which calculates a diameter of a throttle part of a valve and a diameter of an orifice from changes of vacuum degrees measured by vacuum gauges disposed in an ion source and a vacuum chamber having a mass analysis part in order to maintain a flow rate of reagent gas flowing in the ion source to be always fixed and changes vacuum degree in a reagent introduction part, the ion source or the vacuum chamber in order to correct difference from standard value is provided. A unit which measures discharge voltage, discharge current and plasma luminous intensity to grasp current situation in order to maintain plasma generation state in the ion source to be fixed and changes discharge condition such as discharge voltage in order to correct change part from standard value is provided.

### BACKGROUND OF THE INVENTION

The present invention relates to a mass spectrometer and more particularly to a mass spectrometer having a miniaturized size and a reduced weight.

In a mass spectrometer, a reagent which is an object to be analyzed is ionized and ions generated thereby are transported in vacuum. Mass of the ions is separated by utilizing electric field or magnetic field and the separated ions are detected by a detector. Generation of the ions is made under the atmospheric pressure or a low vacuum. Ions or reagent gas is introduced into a mass separation part intermittently, so that a time average inflow into a vacuum chamber to which an evacuation system is connected is reduced to realize miniaturization and reduction in weight of the evacuation system and thus the whole of the apparatus.

JP-A-2008-51504 describes a method in which carrier gas is ionized in a first ionization chamber to jet high-speed current and reagent gas is taken in by negative pressure produced by the high-speed current, so that the reagent gas is made to react to ions or excitation species to generate ions. WO 2009/023361 describes a method or a measure in which electro-spray ionization source, nano-electro-spray ionization source, atmospheric pressure matrix laser supportion source or atmospheric pressure chemical ion source is used as an ion source to lead ions into a silicon tube and the silicon tube is crushed by a pinch valve and is not crushed to thereby take the ions into a mass analysis part intermittently, so that evacuation system is miniaturized and lightened.

### SUMMARY OF THE INVENTION

FIG. 9 schematically illustrates an example of a conventional mass spectrometer. A reagent 1 in the state of liquid or solid is put in a hermetically sealed reagent bottle 2. The reagent bottle 2 is heated by a heater 3 externally. Vaporized gas 4 is generated by heating.

A tube 5 is hermetically connected to the reagent bottle 2 and atmosphere 7 is led in reagent bottle by difference in pressure between a vacuum chamber 13 and the outside. A solenoid valve 6 is disposed downstream of reagent bottle and the vaporized gas 4 flows downstream and is stopped from flowing downstream by opening and closing of the valve.

The valve is opened only during several tens ms from its closed state at intervals of one second by way of example. The vaporized gas 4 flows in a glass tube constituting an ion source 8. Cylindrical electrodes 9 are disposed at two places outside of the glass tube. The electrodes 9 are applied with high frequency voltage of several hundred hertz and several kilo-volts by a high-frequency power source 12 to generate an electromagnetic field in the ion source 8, so that barrier discharge 10 is generated. When the valve 6 is opened only during a fixed time from its closed state and then returned to the closed state, the vacuum degree in the ion source 8 becomes low vacuum once and thereafter vaporized gas 4 flows in the vacuum chamber 13, so that the vacuum degree in the ion source 8 is changed to be high vacuum. Discharge is stabilized within the range of vacuum degree of several hundred to several thousand pascals. Vaporized gas 4 is ionized in the generated discharge area. In order to improve mass spectrometric performance, a mass separation part 14 is required to be high vacuum and an orifice 15 having small hole equal to or smaller than 1 mm in diameter is provided or formed between the ion source 8 and the mass separation part 14 in order to generate difference in vacuum degree.

Ions pass through the orifice 15 and enter the mass separation part 14. The mass separation part 14 accumulates ions in space among four ion trap electrodes by a confining electric field and amplitude or frequency of auxiliary AC voltage superimposed on the ion trap electrode is changed to make ions pass through slit of the ion trap electrodes existing in the direction perpendicular to the axis direction of the ion trap electrodes for each mass-to-charge ratio, so that ions are taken in an ion detector 16 to decide components of the vaporized gas 4. Further, there is also another processing method in which only specific ions are subjected to FNF (Filtered Noise Field) processing to be made to remain in an ion trap area and the ions remained is subjected to CID (Collision Induced Dissociation) processing to be dissolved to generate fragment ions so that the generated fragment ions are introduced into the ion detector 16 in which components thereof are analyzed with higher accuracy. A mass analysis part is composed of the mass separation part 14 formed of four ion trap electrodes, the ion detector 16 and the vacuum chamber 13 enclosing them. The vacuum chamber 13 is evacuated into vacuum by a main vacuum pump 18 such as turbo-molecular pump having large pumping speed. Downstream side of the main vacuum pump 18 is evacuated into vacuum by a rough vacuum pump 17 such as diaphragm pump having relatively small pumping speed. Although not shown in the figure, each electrode is connected to a high-voltage source and the whole of apparatus is controlled by a controller. User uses an operation panel and makes operation while viewing a picture.

Usually, a manufacturer of the mass spectrometer optimizes processing conditions such as application voltage in discharge, an application time and an open and close time of the valve for controlling a flow rate of gas when the mass spectrometer is started and adjusted and confirms desired apparatus performance to be shipped. After shipping, the mass spectrometer is installed in customer's premises and then the mass spectrometer is started and adjusted similarly, so that it is confirmed that the same performance as that at the shipping time is attained and the mass spectrometer is handed over to customer. In the customer, after the trial operation, the mass spectrometer is used for analysis and estimation test and the like. In order to obtain stable apparatus performance after it is used for production and the like for a fixed period, maintenance is performed. In the maintenance, the valve, the orifice, the glass tube and the like contaminated by passing reagent gas therethrough are exchanged.

When a general-purpose solenoid valve is used as valve, a dead space is increased and accordingly reagent gas used before remains in a dead space, so that there arises a contamination problem that the analysis result of the former reagent gas is contained in the analysis result of new reagent. Accordingly, the general-purpose solenoid valve is difficult to use and a generally microminiaturized solenoid valve having a sufficiently small dead space is used. The valve has a valve seat and a valve body therein and the diameter of the flow path which reagent gas flows through is as small as 1 mm or less. The diameter of this part is varied or scattered due to manufacturing tolerance. Since the original dimension thereof is small, the variation range thereof (ratio of actual mechanically processed dimension and standard dimension) is increased. Conductance of the valve (inverse of resistance of the flow path) is varied or scattered due to variation of the dimension and the flow rate of the gas flowing in the ion source is changed, so that an amount of ions generated as a result is changed. Particularly, in a case of viscous flow having a relatively low vacuum degree within the valve, a flow rate of vaporized gas passing through the throttle part of the valve is substantially proportional to the fourth power of the diameter of the flow path and accordingly the flow rate of vaporized gas flowing in the ion source is varied about 50% when the diameter of the flow path is varied 10% on condition that the length of the flow path is identical, so that the amount of ions generated is also varied widely. Further, similarly, the amount of ions flowing in the mass separation part is changed due to the variation of the diameter of the orifice. The fore-going is described concretely with reference to FIG. 9.

When the conductance of the throttle part of the valve 6 is C₁, the conductance of the orifice 15 is C₂ and the conductance between the vacuum chamber 13 and the main vacuum pump 18 is C₃ (=fixed), the flow rate Q₁ of gas flowing through the valve 6 into the ion source (glass tube part) 8 is expressed as follows:

Q₁≈C₁×(P₀−P₁)−C₂×(P₁−P₂) (1)

where P₀ is a vacuum degree in the upstream part of the valve, P₁ a vacuum degree in the upstream part of the glass tube, P₂ a vacuum degree of the vacuum chamber and P₃ a vacuum degree of the main vacuum pump 18.

The flow rate Q₂ of gas flowing into the vacuum chamber is expressed as follows:

Q₂≈C₂×(P₁−P₂)−C₃×(P₂−P₃) (2)

It is understood that Q₁ and Q₂ are changed depending on C₁ and C₂.

Next, the increase dP₁ of pressure in the glass tube part and the increase dP₂ of the pressure in the vacuum chamber during Δt are expressed, respectively, as follows:

dP₁=Q₁/V₁×Δt (3)

dP₂=Q₂/V₂×Δt (4)

where V₁ and V₂ are volumes of the glass tube and the vacuum chamber, respectively, and Δt is a time interval. V₁ is varied or scattered due to manufacturing tolerance of the glass tube (inside diameter and length), although the ratio of manufacturing tolerance (ratio of actual manufactured dimension to standard dimension) is small and can be neglected as compared with variation of the conductance values C₁ and C₂ of the glass tube parts.

The pressure P₁ of the glass tube part and the increased pressure P₂ of the vacuum chamber are expressed by the following expression:

P₁=∫(Q₁/V₁×Δt)dt (5)

P₂=∫(Q₂/V₂×Δt)dt (6)

It is understood that pressure in the glass tube and the vacuum chamber is greatly influenced by the conductance C₁ of throttle part of the valve and the conductance C₂ of the orifice from the expressions (1) to (6).

As described above, inflows of vaporized gas and ions are varied due to the change of the valve and the orifice in each maintenance, so that the apparatus sensitivity is changed and the apparatus performance is unstable. The above circumstances are not limited to only the maintenance time, and even when the reagent gas is attached and deposited on the inner surface of the glass tube and the like in the everyday operation of the apparatus and the cross-sectional area of the flow path is changed, there arises the same problem that vaporized gas flow rate is changed. The discharge state is changed due to the attachment or deposit on the inner surface and even when the apparatus is operated under the same plasma discharge condition, the plasma discharge state is changed and the ion generation amount is varied, so that apparatus sensitivity is changed and the apparatus performance is unstable.

In a conventional mass spectrometer, the mass is corrected in a wide-range mass-to-charge ratio in a calibration operation performed after the maintenance and before the operation of the apparatus and accordingly there is a case where various expensive compound for a mass calibration is used to perform the mass calibration. Preparation of this normal substance and operation amount of the calibration operation are enormous and there is a case where the cost required for the operation is increased to a very large amount.

It is an object of the present invention to provide a mass spectrometer having reduced cost required for operation, high throughput, high reliability and excellent operability by inexpensively and simply performing conventional expensive calibration operation requiring a long time.

The mass spectrometer of the present invention in which reagent gas flows in an ion source pulsatively by the opening and closing of a valve and the reagent gas is ionized in the ion source, the ions entering a mass separation part in a vacuum chamber through an orifice, the ions having a different mass-to-charge ratio every time entering a detector to make analysis has the following constitution.

(1) A flow rate of the reagent gas flowing in the ion source is always maintained to be fixed. Accordingly, for this purpose, there is provided a means to calculate a diameter of a throttle part of a valve and a diameter of the orifice from changes of vacuum degrees measured by vacuum gauges disposed in the ion source and the vacuum chamber at the time of opening and closing of the valve and change a vacuum degree in a reagent introduction part, the ion source or the vacuum chamber in order to correct a difference from a standard value.
(2) The plasma generation state in the ion source is maintained to be fixed. For this purpose, there is provided a means to measure a discharge voltage, a discharge current and a plasma luminous intensity to grasp a current situation and change a discharge condition such as the discharge voltage in order to correct a change part from the standard value.
(3) An amount of ions flowing in the mass separation part is maintained to be fixed. For this purpose, there is provided a means to change the discharge condition such as a discharge time in order to correct the change part of the diameter of the orifice.

According to the present invention, there can be provided the mass spectrometer having reduced cost required for operation, high throughput, high reliability and excellent operability by inexpensively and simply performing the conventional expensive calibration operation requiring a long time.

Other problems, constitution and effects except the foregoing are apparent from the following description of embodiments.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram illustrating a mass spectrometer according to an embodiment of the present invention;

FIG. 2 is a graph showing change of a vacuum degree in a glass tube by opening and closing of a valve;

FIG. 3 is a graph showing a relation of a conductance of the throttle part of the valve and change of a vacuum degree in a glass tube by opening and closing of the valve;

FIG. 4 is a diagram illustrating plasma spectrometry;

FIG. 5 is a flow chart showing an example of adjustment procedure;

FIG. 6 is a schematic diagram illustrating a mass spectrometer according to another embodiment of the present invention;

FIG. 7 is a schematic diagram illustrating a mass spectrometer according to another embodiment of the present invention;

FIG. 8 is a diagram showing an operation panel picture with which adjustment operation is performed; and

FIG. 9 is a schematic diagram illustrating a conventional mass spectrometer.

### DETAILED DESCRIPTION OF THE INVENTION

Embodiments of the present invention are now described with reference to the accompanying drawings.

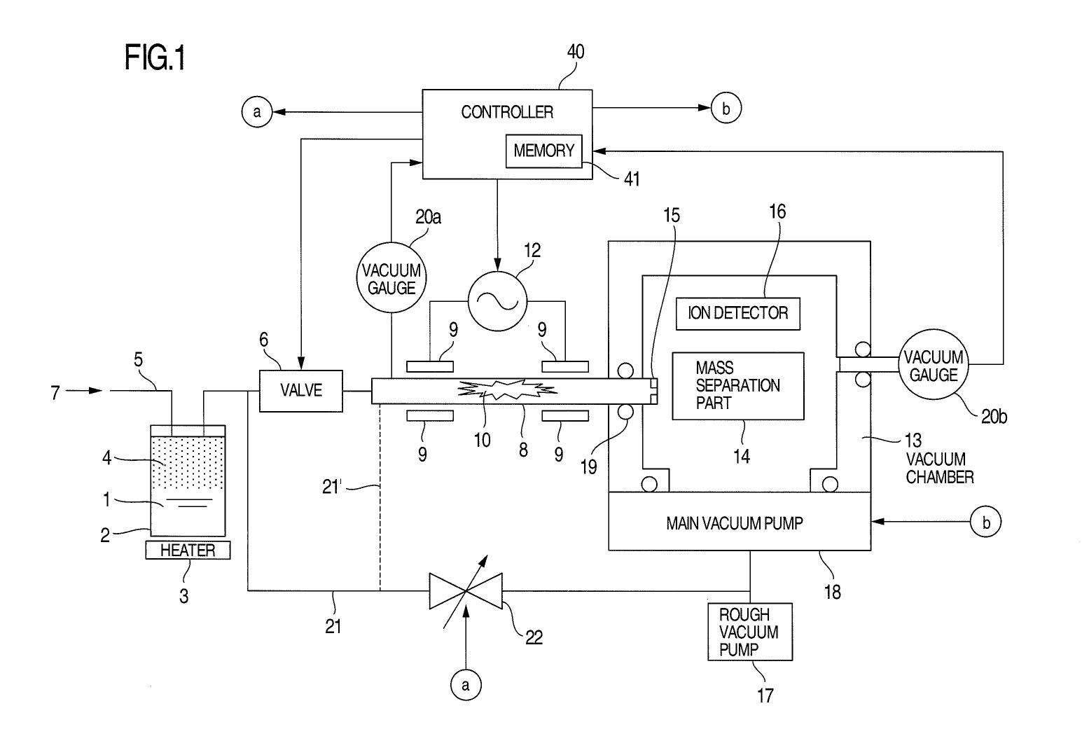

FIG. 1 is a schematic diagram illustrating a mass spectrometer according to an embodiment of the present invention. The mass spectrometer of the embodiment is different from the conventional apparatus in that vacuum gauges 20a and 20b are added to be able to measure vacuum degrees in a glass tube constituting an ion source 8 and a vacuum chamber 13 and the upstream part of the valve 6 and a rough vacuum pump 17 are connected by an exhaust pipe 21 through a flow-rate adjustment valve 22 in order to adjust vacuum degree in the upstream part of the valve 6.

Since vaporized gas 4 is introduced pulsatively, vacuum degrees in the ion source 8 and the vacuum chamber 13 are changed large in a short time. As the vacuum gauges 20a and 20b, vacuum gauges each of which can make measurement at a high speed with a time lag of about ten milliseconds are desired. The vacuum gauges 20a and 20b are connected through O-rings 19 and joints to the ion source 8 and the vacuum chamber 13.

An opening degree of the flow-rate adjustment valve 22 can be adjusted to thereby change pressure loss so that the vacuum degree in the upstream part of the valve 6, that is, the vacuum degree in a reagent introduction part can be changed. The flow-rate adjustment valve 22 is opened completely at opening degree of 100% and closed tightly at the opening degree of 0%. When the opening degree is increased, the vacuum degree in the upstream part of the valve 6 is a high vacuum and when the opening degree is reduced, the vacuum degree is low vacuum. The flow-rate adjustment valve 22 may have a function of changing freely the opening degree manually or electrically. In order to change the vacuum degree in the upstream part of the valve 6, the inner diameter and the length of a tube 5 can be changed to make small conductance and vacuum degree on the upstream side of the valve 6 can be changed to a high vacuum without using the flow-rate adjustment valve 22. The exhaust pipe 21 uses a metallic flexible tube or a stainless tube if high vacuum seal performance is necessary and uses a rubber or resin pipe if high vacuum seal performance is not necessary. A pipe on the downstream side of the flow-rate adjustment valve 22 can be connected to a pipe between the compression parts of the rough vacuum pump 17 so as to suppress a problem of reduction in an exhaust speed due to condensation phenomenon of water produced by the relation of the vacuum degree and the surrounding environment temperature of the pipe.

Data of a vacuum degree of the ion source 8 measured by the vacuum gauge 20a, a vacuum degree of the vacuum chamber 13 measured by the vacuum gauge 20b and a measured value in a plasma state of the ion source described later are supplied to a controller 40. The controller 40 performs the open and close control of the valve 6, the control of the opening degree of the flow-rate adjustment valve 22, the control of the high-frequency power source 12 for generating barrier discharge 10 in the ion source 8, the control of the rotation rate of a main vacuum pump 18 and the like. Further, an apparatus adjustment program is stored in a memory 41 of the controller 40 and the controller 40 collects data of each part of the apparatus in accordance with the apparatus adjustment program described later and controls the opening degree of the flow-rate adjustment valve 22, the rotation rate of the main vacuum pump 18, a discharge voltage and a discharge time of the high-frequency power source 12 and the like so that the amount of ions flowing in a mass separation part 14 is fixed finally.

Method and measure used to make the flow rate of vaporized gas flowing in the ion source 8 fixed are described concretely.

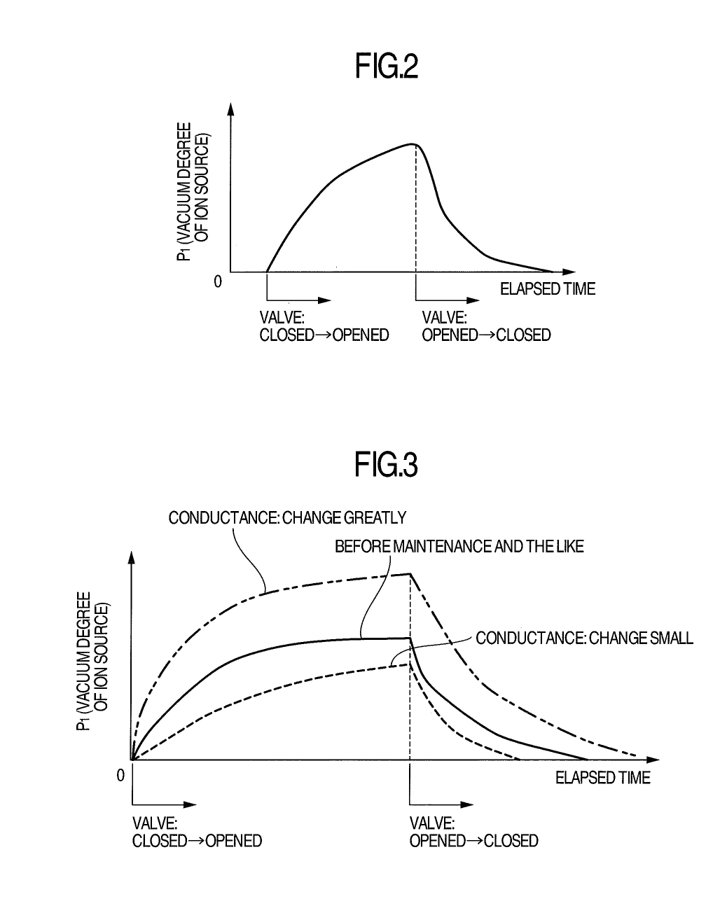

FIG. 2 is a graph showing a time elapsed in case where the valve 6 is changed to be opened from its closed state and then closed again (closed→opened→closed) and also showing the change of vacuum degree in the ion source 8. The valve 6 is operated to be opened from its closed state and then closed again (closed→opened→closed) pulsatively so that the vaporized gas 4 flows in pulsatively. The opening time of the valve is about ten-odd milliseconds. When the valve 6 is operated to be opened from its closed state (closed→opened), the vaporized gas 4 flows in and accordingly the vacuum degree in the glass tube constituting the ion source 8 is changed to a low vacuum and when the valve 6 is operated to be closed from its opened state (opened→closed), the vaporized gas passes through the orifice 15 to be merely exhausted and accordingly the vacuum degree is changed to a high vacuum.

A time constant τ₁ representative of a ratio of the change of the vacuum degree to a time elapsed after the closing of the valve is proportional to V₁ (volume of the ion source 8)/S₁ (combined exhaust speed). S₁ depends on (1) a conductance C₂ of the orifice, (2) a conductance decided by the structure of the mass separation part 14, (3) a conductance C₃ decided by the structure between the main vacuum pump 18 and the mass separation part 14 and (4) a combined conductance which is substantially decided by the exhaust speed of the main vacuum pump 18, and the parameters in the above items (2), (3) and (4) are regarded as being substantially fixed unless the main vacuum pump 18 breaks down. In order to calculate the combined conductance of the above items (2), (3) and (4) which does not contain the conductance C₂ of the orifice 15, the change of the vacuum degree of the vacuum chamber 13 after closing of the valve 6 is measured similarly and the fact that this time constant is proportional to a V₂ (volume of the space of the vacuum chamber 13)/S₂ (combined exhaust speed of the above items (2) to (4)) is utilized. Hence, by calculating the time constant τ₁ from the actually measured value, V₁ (volume of the glass tube of the ion source) is calculated from the shape and accordingly S₁ (combined exhaust speed) is calculated in accordance with the above items (1) to (4). Since the conductance values in the above items (2) to (4) are already calculated, the conductance C₂ of the orifice 15 is calculated and the diameter of the orifice is calculated.

FIG. 3 is a graph showing the relation of the change of the conductance of the throttle part of the valve 6 and the change of the vacuum degree of the ion source 8. When the valve 6 is opened from its closed state (closed→opened), the vaporized gas 4 flows in the ion source 8 and the vacuum degree of the glass tube constituting the ion source is changed to be a low vacuum. A part of the vaporized gas 4 flowing in the ion source passes through the orifice 15 and flows out from the ion source to enter the vacuum chamber 13. The vacuum degree is in the steady state and fixed when flowing-in gas is balanced with flowing-out gas. When the opening time of the valve is short, the steady state is not reached and the vacuum degree of the ion source is always changed with a time elapsed. When the conductance of the valve is increased as compared with before the maintenance (when the resistance of the flow path is made small), the flow rate of the vaporized gas flowing in the valve is increased and the vacuum degree of the ion source 8 is changed to be a lower vacuum. Conversely, when the conductance is made smaller (when the resistance of the flow path is increased), the vacuum degree of the ion source is changed to be a high vacuum. Next, when the valve is closed from its opened state (opened→closed), the vaporized gas enters the vacuum chamber 13 through the orifice 15 and accordingly the vacuum degree is changed to be a high vacuum. The change of the vacuum degree caused by a difference of the conductance is as shown in the figure.

In the expression (1), P₁ (actually measured value), P₂ (actually measured value) and C₂ (conductance of the orifice calculated from the actually measured value) have been calculated except the conductance C₁ of the valve 6. P₀ (vacuum degree in the upstream part of the valve 6) shown in FIG. 9 is calculated by measuring it upon start of the apparatus. P₀ value is fixed unless the rough vacuum pump 17 breaks down. Q₁ can be calculated using the relational expression (3) from change of the vacuum degree of the ion source to time elapsed after the valve 6 is opened from its closed state (closed→opened). The conductance C₁ of the throttle part of the valve is calculated from Q. According to the above method, the conductances (that is, diameters) of the throttle part of the valve and the orifice are calculated.

It is understood that Q₁ (actually measured value of the flow rate of the gas after the maintenance and the calibration) can be made to be equal to the value before the maintenance or after the calibration by changing P₀ from the expression (1).

P₀ is changed by the flow-rate adjustment valve 22 shown in FIG. 1. When P₀ is changed, P₁ and P₂ are changed although C₁ and C₂ are not changed and accordingly P₀ is changed to actually measure P₁ and P₂, so that value of the expression (1) can be made to be equal to the same value as before the maintenance or the calibration. According to the above operation, the amount of the vaporized gas flowing in the ion source 8 is fixed. From the expression (3), the increase of the pressure in the ion source 8 is identical before and after the maintenance and if the plasma discharge state is not changed, the amount of ions generated in the ion source 8 is identical.

In the above description, Q₁ is made to be the same value by changing P₀, although a method in which the vacuum degree P₁ in the ion source (glass tube and the like) and the vacuum degree P₂ in the chamber are changed while P₀ is fixed, so that Q₁ is made to be fixed may be used. In order to change the vacuum degrees P₁ and P₂, the exhaust pipe 21 on the upstream side of the flow-rate adjustment valve 22 may be connected to the ion source (glass tube and the like) 8 as shown by a broken line 21′ in FIG. 1, for example, although the exhaust pipe 21 on the upstream side of the flow-rate adjustment valve 22 is connected to the upstream side of the valve 6 in FIG. 1. Alternatively, there is another method in which the rotation rate of the main vacuum pump 18 is changed to a vary pumpling speed. Alternatively, it can be also realized by making gas which does not influence the analysis flow in the vacuum chamber 13 only by minute quantities using the mass flow controller to change the vacuum degrees P₁ and P₂ to be a low vacuum.

Next, a method in which the discharge voltage, discharge current, plasma luminous intensity and the like are measured to grasp the current situation and the plasma discharge condition is adjusted to correct the change part from the standard value in order to fix the plasma discharge condition in the ion source is described below.

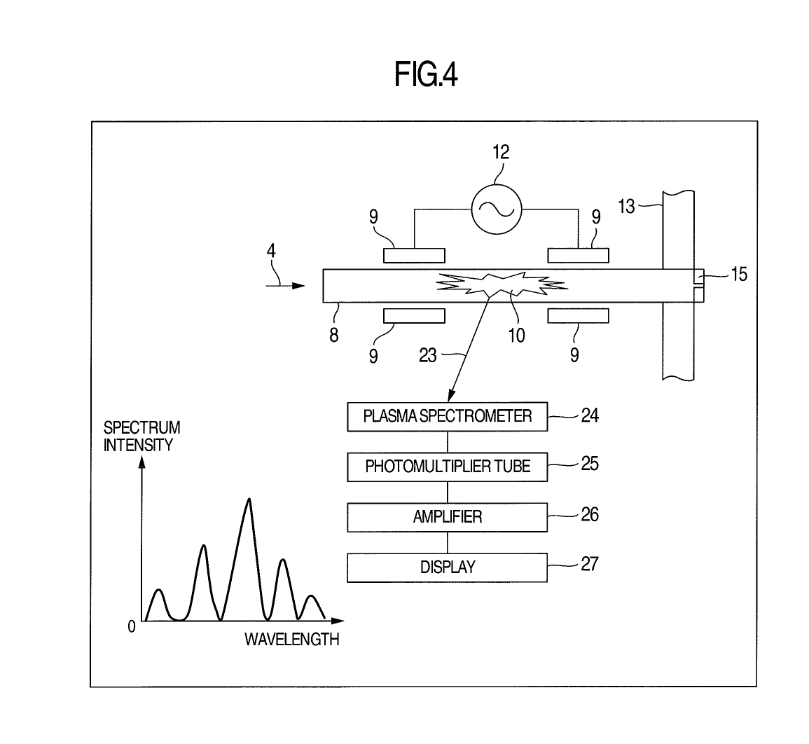

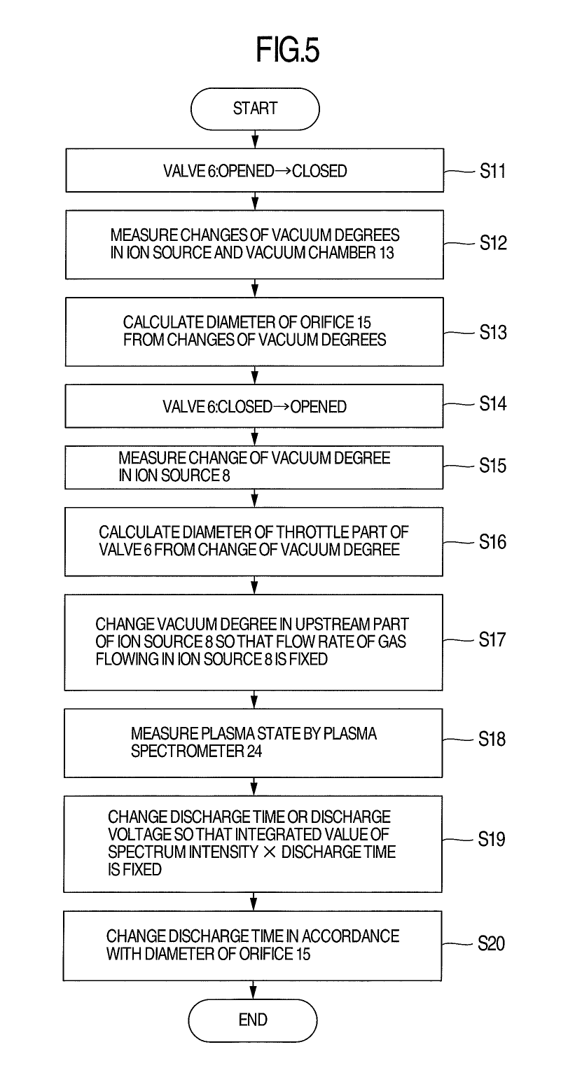

FIG. 4 schematically illustrates the plasma measurement using a plasma spectrometer 24. It is known that when atoms and molecules excited in plasma are transited to low energy, light of luminous spectrum inherent to the plasma state is emitted. Luminescence or emitted light 23 from the barrier discharge part 10 is taken in the plasma spectrometer 24 and an output signal from an optical detector such as a photomultiplier tube 25 is electrically amplified by an amplifier 26 to display information in a display 27. An example of the information displayed in the display 27 is shown left in the figure. A spectrum waveform as shown in the figure is obtained in which the horizontal axis represents a detection wavelength and vertical axis represents a spectrum intensity. The state of plasma such as an electron density, an electron temperature, the number of atoms and the like can be understood from the spectrum waveform. Measured data is sent to the controller 40 and the controller uses the data to perform a data processing described later. The controller controls the high-frequency power source 12 on the basis of its result. Further, when the plasma discharge state is automatically controlled by the controller 40, it is not necessarily required to display information such as luminous spectrum in the display 27.

In the above method, the plasma luminous states are compared before and after the maintenance and before and after the calibration, so that change of the plasma states can be detected. In order to correct this change part, the plasma discharge condition is changed. For example, though the plasma discharge state (discharge voltage, discharge current and the like) is the same before and after the maintenance or the calibration, when an integrated value is changed to a wavelength of luminous spectrum due to any factor, the discharge voltage is increased or decreased, so that the integrated value of spectrum to wavelength of the luminous spectrum is made identical. An ion generation amount within a certain discharge time is made identical by this operation. The discharge voltage may be changed by this operation so as to fix the spectrum intensity of a specific wavelength while paying attention to the specific wavelength instead of the integrated value of the spectrum. Moreover, a plasma turning-on time may be changed so as to fix a value obtained by multiplying the spectrum integrated value by the plasma turning-on time without changing the discharge voltage. When the spectrum integrated value is smaller than the standard value, the discharge time is increased. Conversely, when the spectrum integrated value is larger, the discharge time is shortened and the ion generation amount within the discharge time is made identical.

The total number of ions generated within the plasma turning-on time is substantially fixed by the above operation. Even when the discharge state is changed, the amount of ions generated can be fixed. According to the above-mentioned method, the flow rate of the vaporized gas flowing in the glass tube is fixed and the total number of ions generated in the ion source is substantially identical.

Next, the method of fixing the amount of ions flowing in the mass separation part always, that is, the method of changing the discharge condition such as the discharge time in order to correct a difference from the standard value based on change in the diameter of the orifice is described.

The total number of ions flowing in the mass separation part 14 within a fixed time is substantially proportional to the cross-sectional area of the orifice 15 and accordingly when the orifice diameter is changed before and after the maintenance or the calibration, for example, when the orifice diameter is made smaller, the total number of ions is reduced and conversely when the orifice diameter is increased, the total number of ions is increased. In order to correct a difference of the orifice diameter, the discharge time may be changed as one method. That is, when the orifice diameter is larger, the discharge time is shortened in accordance with the inverse of the orifice area ratio and conversely when the orifice diameter is smaller, the discharge time is lengthened. The same effect can be obtained by making plasma set in the discharge state continuously and disposing the shutter valve between the ion source and the mass separation part to change the opening time of the valve so that the number of ions flowing in the mass separation part is made identical. By performing the above operation, change of the number of ions flowing in the mass separation part 14 due to change of the orifice diameter can be removed.

FIG. 5 is a flow chart showing the above adjustment contents by way of example.

First, the valve 6 is changed from the opened state to the closed state (S11) and changes of the vacuum degrees in the ion source 8 and the vacuum chamber are measured (S12). The diameter of the orifice 15 is calculated on the basis of the changes of the vacuum degrees (S13). Then, the valve 6 is changed from the closed state to the opened state (S14) and the change of the vacuum degree in the ion source 8 is measured (S15). The conductance of the valve 6, that is, the diameter of the throttle part of the valve 6 is calculated therefrom (S16). Next, for example, the flow-rate adjustment valve 22 is adjusted to change the vacuum degree P₀ in the upstream part of the ion source 8, so that the flow rate of gas flowing in the ion source 8 is fixed (S17). According to this adjustment, the amount of the vaporized gas 4 flowing in the ion source 8 is fixed and the change of the vacuum degree in the ion source 8 is made identical before and after the maintenance.

Next, the state of plasma is measured by the plasma spectrometer 24 (S18). The discharge time or the discharge voltage of the ion source 8 is changed so that the integrated value of the spectrum intensity×the discharge time is fixed on the basis of the measured plasma state, for example (S19). This adjustment fixes the ion generation amount before and after the maintenance. Next, the discharge time of the ion source 8 is changed in accordance with the diameter of the orifice 15 (S20). By making this adjustment, the amount of ions flowing in the mass separation part 14 is fixed before and after the maintenance.

Thus, there can be provided the mass spectrometer having high throughput, high reliability and excellent operability. The series of processing shown in FIG. 5 is automatically performed in accordance with the adjustment program stored in the memory 41 of the controller 40.

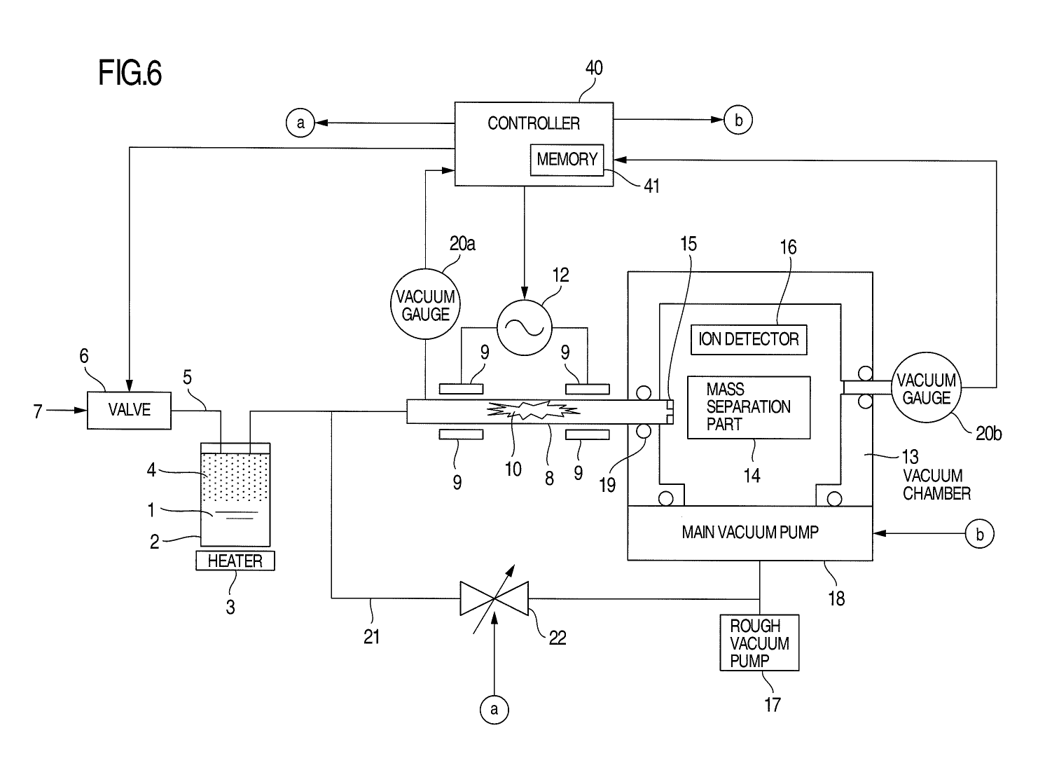

FIG. 6 is a schematic diagram illustrating a mass spectrometer according to another embodiment of the present invention. The mass spectrometer of this embodiment is different from the embodiment of FIG. 1 in that the positions of the reagent and the valve are replaced.

The merit of the embodiment resides in that the vaporized gas 4 does not pass through the valve 6 and accordingly the inside of the valve 6 is prevented from being contaminated by the vaporized gas 4, so that it is not necessary to exchange the valve 6. Components requiring the maintenance are the glass tube constituting the ion source 8 and the orifice 15. Since the conductance of the valve 6 is not changed, the adjustment and the calibration after the maintenance are simplified. Considering a weak point, the reagent is continuously vaporized in a reagent bottle 2 by amount of the vaporized gas flowing in the vacuum chamber even when the valve 6 is closed and accordingly contamination of the glass tube constituting the ion source 8 and the orifice 15 is increased. In order to prevent this, there is a method in which a filter having large pressure loss is inserted in exit of the reagent bottle 2 to reduce the flow rate of vaporized gas, although there sometimes arises a problem that the gas flow rate at the time of actual generation of ions cannot be secured sufficiently.

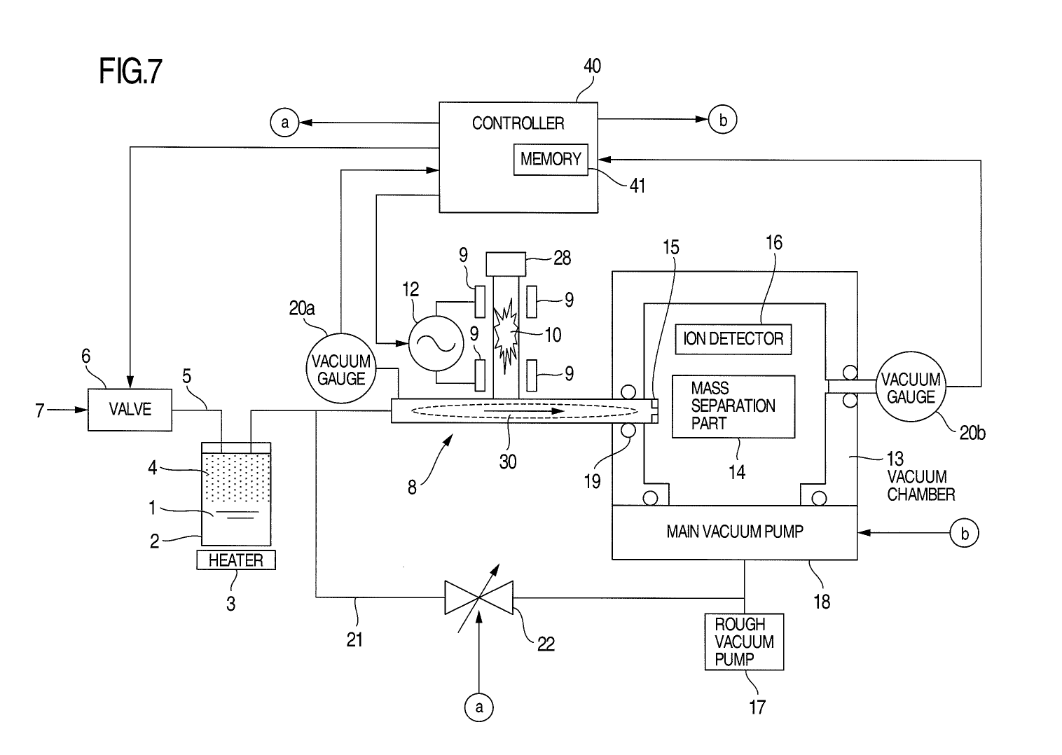

FIG. 7 is a schematic diagram illustrating a mass spectrometer according to a further embodiment of the present invention. The mass spectrometer of this embodiment is different from the embodiment of FIG. 1 in that the glass tube constituting the ion source 8 is not straight but is formed into a letter T. Barrier discharge 10 is performed near the branch part of letter T, so that an area 30 which the vaporized gas 4 flows through can be separated from the barrier discharge area. An end of the T-shaped glass tube is hermetically sealed by a sealing plug 28.

In the constitution shown in FIG. 1, since the vaporized gas 4 passes through the barrier discharge area, high-energy ions and electrons directly react to the vaporized gas 4 to generate a lot of fragment ions. There is also a method in which capillary is disposed throughout the inside of the glass tube and the vaporized gas 4 is fed downstream separately from the barrier discharge area, so that the reaction of the vaporized gas 4 to high-energy ions and electrons is avoided, although there is a problem that the structure is complicated.

According to the construction of the embodiment, high-energy ions and electrons generated in the barrier discharge area 10 disappear due to collision with remaining gas during the movement of the distance existing until high-energy ions and electrons react to the vaporized gas 4, so that low-energy ions and electrons become main components and soft ionization can be attained as compared with the electron impact ionization method. Consequently, it is difficult that vaporized gas molecules are broken due to reaction to ions and electrons and parent ions become main components, so that the generation amount of fragment ions is reduced and an ionization method suitable for detection of medication is attained. Further, in the example shown in FIG. 7, the valve 6 is disposed the upstream of the reagent bottle 2, although the valve 6 may be disposed between the reagent bottle 2 and the ion source 8 as shown in FIG. 1.

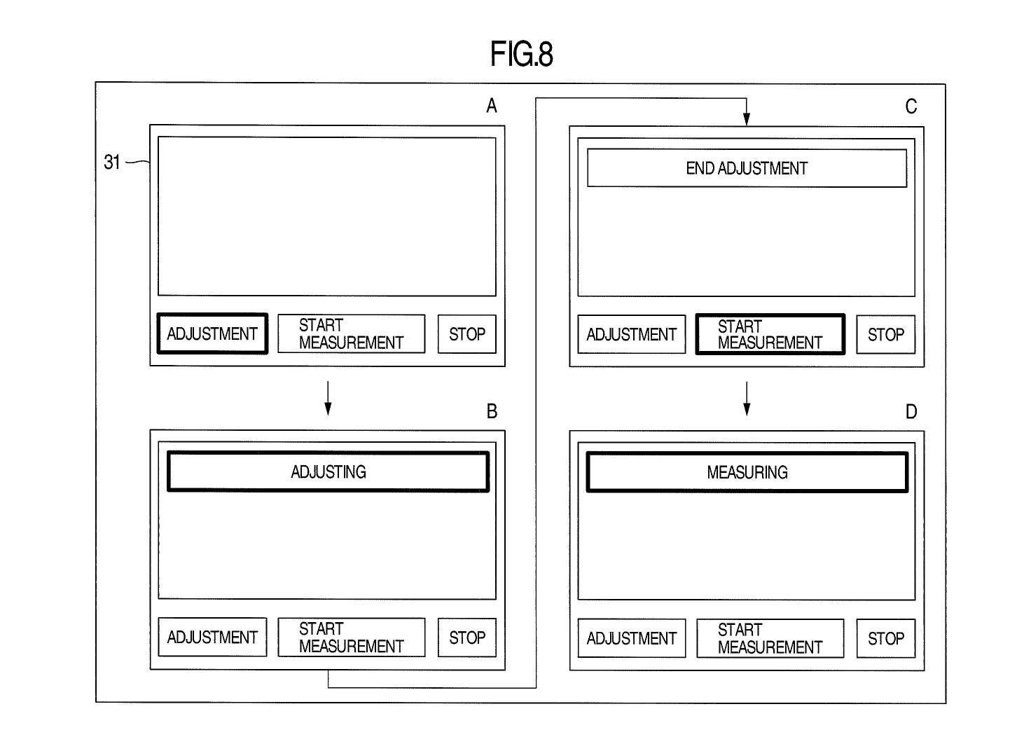

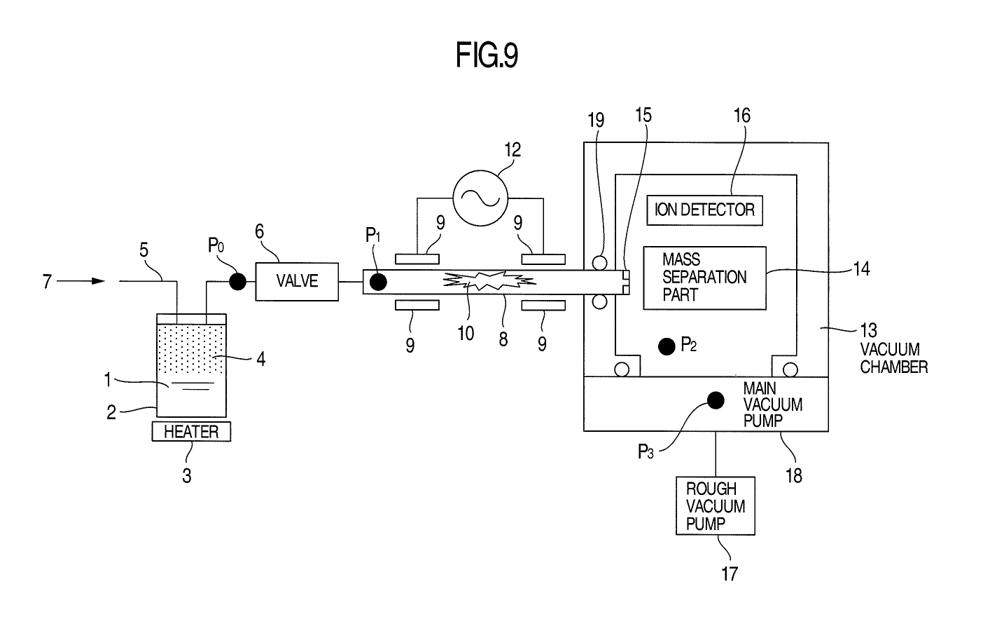

FIG. 8 shows an example of an operation picture of the apparatus. This is the operation picture of the mass spectrometer and a user or operator pushes an “adjustment” button on the operation picture upon the calibration performed after the maintenance (A). As a result, the adjustment operation as shown in FIG. 5 is started automatically. After a while, the operation picture is changed to a picture representing the adjusting (B). When the adjustment operation is ended, the measurement start button is automatically turned on and off and a user is notified of the analysis start (C). When a “start measurement” button is pushed, the mass analysis operation is started and a picture representing “measuring” is displayed (D). When the measurement is ended, an analysis result is displayed on the picture.

The present invention is not limited to the above embodiments and contains various modification examples. For example, the embodiments are described in detail in order to explain the present invention simply and it is not necessarily limited to include all constituent elements described. Parts of the constituent elements of the one embodiment can be replaced by the constituent elements of the another embodiment and the constituent elements of the one embodiment can be added to the constituent elements of the another embodiment. Addition, deletion and replacement of the other constituent elements can be made to parts of the constituent elements of the embodiments.

Further, part or the whole of the above configurations, functions, processing units, processing means and the like may be realized in hardware by being designed by, for example, integrated circuits. Moreover, the above configurations and functions may be realized by software by interpreting programs for realizing functions to be executed by processor. Information of programs, tables, files and the like for realizing functions can be stored in recording device such as memory, hard disk, SSD (Solid State Drive) or recording medium such as IC card, SD card and DVD.

It should be further understood by those skilled in the art that although the foregoing description has been made on embodiments of the invention, the invention is not limited thereto and various changes and modifications may be made without departing from the spirit of the invention and the scope of the appended claims.

1. A mass spectrometer including:
an ion source which ionizes reagent gas;
a reagent introduction part which feeds the reagent gas to the ion source pulsatively;
a mass separation part which is disposed in a vacuum chamber and separates ions of the reagent gas ionized by the ion source in a mass-to-charge ratio;
an orifice which is disposed between the ion source and the mass separation part to pass ions therethrough;
an ion detector which detects ions separated by the mass separation part;
a first vacuum gauge which measures a vacuum degree in the ion source;
a second vacuum gauge which measures a vacuum degree in the vacuum chamber; and
means which changes the vacuum degree in at least one of the reagent introduction part, the ion source and the vacuum chamber.

2. The mass spectrometer according to claim 1, wherein
the reagent introduction part includes a reagent vessel in which reagent is put and a valve disposed in a pipe which connects the reagent vessel to the ion source, and vaporized gas from reagent in the reagent vessel is fed to the ion source pulsatively by opening and closing of the valve.

3. The mass spectrometer according to claim 1, wherein
the reagent introduction part includes a reagent vessel in which reagent is put, a pipe to connect the reagent vessel to the ion source and a valve disposed on upstream side of the reagent vessel, and vaporized gas from reagent in the reagent vessel is fed to the ion source pulsatively by opening and closing of the valve.

4. The mass spectrometer according to claim 1, comprising
a pipe to connect the reagent introduction part or the ion source to a vacuum pump and a flow-rate adjustment valve disposed in the pipe.

5. The mass spectrometer according to claim 1, wherein
the means calculates a conductance of a throttle part of a valve disposed in the reagent introduction part and a conductance of the orifice from change of vacuum degrees of the ion source and the vacuum chamber caused by opening and closing operation of the valve in order to feed the reagent gas to the ion source pulsatively and changes a vacuum degree in the reagent introduction part, the ion source or the vacuum chamber to correct deviation amount from a standard value and maintain a flow rate of the reagent gas flowing in the ion source to a fixed value.

6. The mass spectrometer according to claim 1, further comprising
a power source which generate plasma discharge in the ion source;
a controller which controls the power source;
a plasma spectrometer which monitors a state of the plasma discharge; and
a data processing unit which processes data obtained from the plasma spectrometer.

7. The mass spectrometer according to claim 6, wherein
the controller changes plasma discharge condition so that an integrated value of spectrum intensity for each wavelength separated or obtained by being subjected to spectral analysis by the plasma spectrometer is substantially identical or controls a discharge time so that an integrated value of the discharge time and the spectrum intensity is substantially identical before and after maintenance or calibration.

8. The mass spectrometer according to claim 6, further comprising
means which calculates differences between standard value and current measured value of discharge voltage or discharge current of the plasma discharge before maintenance or apparatus performance calibration and changes plasma discharge condition in order to correct the differences and maintain plasma discharge state in the ion source to be fixed.

9. The mass spectrometer according to claim 5, wherein
the controller corrects a change part of a diameter of the orifice and changes a plasma discharge time so that an amount of ions flowing in the mass separation part is fixed.
